(19) United States
(12) Patent Application Publication
(10) Pub. No.: US 2005/0248351 A1
(43) Pub. Date: Nov. 10, 2005

(54) Self-calibrating device for measuring voltage and corresponding method

(75) Inventor: Hans-Michael Graf, Bad Abbach (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 11/125,550

(22) Filed: May 9, 2005

(30) Foreign Application Priority Data
May 7, 2004 (DE) 102004022556.7

(51) Int. Cl. H02J 7/04

(52) U.S. Cl. 324/433

(57) ABSTRACT

A device for measuring a battery voltage is a self-calibrating device. The battery voltage is connected to a voltage divider formed of series-connected resistors, or components that are subject to a voltage drop. For the purposes of calibration the voltage divider is separated from the battery voltage and a reference current or reference voltage source is connected to the voltage divider in its place. The voltages dropping across the voltage divider are measured and an actual resistance ratio of the resistors of the voltage divider is calculated, based on the measured voltages. The voltage divider is then re-connected to the battery voltage that is to be measured and a battery voltage is determined with the aid of the voltage divider, taking into account the calculated resistance ratio.

### BACKGROUND OF THE INVENTION

### Field of the Invention

The invention relates to a device and a method for measuring voltage, more particularly to a self-calibrating voltage measuring device for a battery sensor in a motor vehicle, as well as to a method herefor.

In an electronic battery management system in motor vehicles, a current, a voltage and a temperature are generally measured, the voltage of a battery preferably being measured by means of a resistance divider (voltage divider). In that case the measured voltage is divided by the theoretically known ratio of the two resistances in order to calculate the actual voltage.

However, the measured voltage is dependent on an actual ratio of the two resistances, which is affected for example by aging effects of the resistors or changes in temperature.

In addition to the use of extremely precise resistors (with extremely low aging rates and a temperature coefficient TC of, for example, less than 8 ppm/K), which are disproportionately expensive, there is the possibility of calibrating the entire battery sensor at different temperatures. However, this has a disadvantageous impact on the manufacturing costs, since the battery sensor must pass through a temperature chamber at the end of production, with still no satisfactory solution being found to the aging problem.

German patent DE 199 473 01 C1 discloses a device and a method for calibrating current sensors through use of a constant current sink in a multi-stage method. For this purpose it is however necessary for the constant current sink to operate with a high degree of precision under all conditions. A constant current sink of this kind constitutes an additional cost-driving component.

German published patent application DE 1 96 447 65 A1 describes a method for tuning measuring circuit arrangements which is very accurate, in which the effects of any error sources are minimized and which can be implemented by means of a relatively robust design. In this case the correction factor of the respective measuring circuit arrangement is calculated by forming the quotient from the reference voltage drop for the measurement resistor and the voltage drop actually determined at the sensing device. However, an accurate measurement resistor is used as a measurement sensor.

The disclosure in German patent DE 1 02 298 95 B3 makes it possible, by determining the resistance value of a shunt resistor, to use a shunt resistor whose resistance value is initially not known precisely but which is economically priced instead of an expensive precision shunt. The resistance value of the shunt resistor, which is required for determining the charge state (state of health) of the battery is then determined to a desired degree of accuracy at an arbitrarily specifiable time. Toward that end, a reference resistor is connected in parallel and preferably temporarily into the series circuit consisting of battery and shunt resistor and the electrical quantity occurring in each case at the shunt resistor and at the reference resistor evaluated. The resistance value of the shunt resistor can thus be determined with a degree of accuracy, which is now only dependent on the accuracy of the knowledge of the resistance value of the reference resistor. As said reference resistor can be a commercially available standard low-power resistor, it is available at a very reasonable price as a mass product in spite of its relatively high accuracy. By using a reference resistor of sufficient accuracy it is possible to measure the resistance value of the low-cost shunt resistor with a degree of accuracy that corresponds to the tolerance range of a precision shunt.

The ability to determine the resistance value of the shunt resistor with a desired degree of accuracy at any moment in time makes it possible to determine effects such as, for example, temperature drift or a change in the resistance value of the shunt resistor due to aging.

A battery condition detection configuration for a battery, which is connected to a microprocessor is disclosed in European patent application EP 1 429 151 A1 corresponding to published patent application US 2004/178,769. There, a circuit configuration is embodied between the microprocessor and the battery, the circuit configuration having at least means for measuring the voltage, means for comparing the voltage and means for generating a control pulse and said means being connected to the microprocessor via corresponding connections. With that system, different measured voltages are compared with one another for the purpose of detecting the condition of the battery and the result of the comparison is supplied to the microprocessor.

In accordance with German patent DE 1 02 288 06 B3, further battery parameters in addition to the load (“consumer”) current are recorded, preferably successively at short time intervals, in exemplary embodiments. Those parameters include, for example, the temperature of the battery and a terminal voltage. Current measurements are performed. If a new operating condition or the combination of a plurality of operating conditions has already occurred once, no current measurement is performed because the current value that was already recorded earlier and is assigned to this operating condition is stored in a register arrangement and can be loaded for computation purposes into the arithmetic unit.

### SUMMARY OF THE INVENTION

It is accordingly an object of the invention to provide a method and self-calibrating device for voltage measurement which overcomes the above-mentioned disadvantages of the heretofore-known devices and methods of this general type and which enables the substantial elimination of aging phenomena of components and the effects of temperature during the measurement of the voltage, and which provides for a corresponding method for the voltage measurement.

With the foregoing and other objects in view there is provided, in accordance with the invention, a device for measuring voltage, comprising:
a voltage divider formed by series-connected resistors R₃, R₄ for measuring a battery voltage V₀;
a first switch having an open position disconnecting the battery voltage from said voltage divider;
a second switch having a closed position connecting a reference current source or a reference voltage source to said voltage divider;
a measuring device connected to said voltage divider for measuring respective voltages dropping across said voltage divider; and
a calculating device connected to said measuring device and configured to calculate an actual resistance ratio of said resistors R₃, R₄ of said voltage divider based on the measured voltages when said second switch is in the closed position, and an actual battery voltage based on the calculated resistance ratio.

In other words, according to the invention the voltage-measuring device includes a voltage divider consisting of series-connected resistors, via which voltage divider the voltage of a battery in a motor vehicle, for example, is measured. In order to take account of aging phenomena of the resistors of the voltage divider, an actual resistance ratio is calculated first by connecting a reference current source or a reference voltage source to the voltage divider. The voltage divider is then separated from the reference current or reference voltage source and connected to the battery. The actual battery voltage is determined from a voltage that is now dropping across the voltage divider, taking into account the previously calculated actual resistance ratio of the resistors of the voltage divider. By this means it is possible to factor in, for example, aging phenomena of the resistors of the voltage divider during the measurement of the battery voltage and to obtain a correct battery voltage value in a simple manner. In this arrangement the voltage-measuring device operates as a self-calibrating instrument, since the actual resistance ratio can be determined automatically at any given time.

In accordance with an added feature of the invention, at least one of the series-connected resistors is a component across which voltage drops. In other words, other components across which voltage drops can also be provided in place of the resistors R₃ and/or R₄. The term “resistor” as used throughout this description and the claims is therefore to be understood in a general sense and also includes active components or general components across which voltage drops.

In accordance with an added feature of the invention, the device includes a temperature sensor. The latter continuously detects momentary temperature values for example, whereby the voltage measuring device calibrates itself automatically if, for example, specific temperature values are present.

In this way it is possible to take account of temperature effects during the measurement of the battery voltage in a simple manner without the need to use disproportionately expensive resistors with an accuracy of, for example, TC<8 ppm/C.

In accordance with an additional feature of the invention, the device includes a memory in which the resistance ratios already calculated at specific temperatures are stored.

As a result it is not necessary to perform the self-calibration once again if, for example, resistance ratios have already been calculated for specific temperatures and stored in the memory.

The device and the method for measuring voltage can be used in a variety of fields of application, in particular in areas in which extremely accurate temperature-independent measurement results are required, without the need to use expensive components (resistors) with extremely low aging rates and a TC of less than 8 ppm/K.

Other features which are considered as characteristic for the invention are set forth in the appended claims.

Although the invention is illustrated and described herein as embodied in a self-calibrating device for measuring voltage and method therefor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a self-calibrating device for measuring a battery voltage according to a first exemplary embodiment of the invention;

FIG. 2 is a flowchart of a preferred exemplary embodiment of a method for automatic calibration of the device according to FIG. 1; and

FIG. 3 is a block diagram of a self-calibrating device for measuring a battery voltage according to a second exemplary embodiment of the invention.

### DESCRIPTION OF THE PREFERRED EMBODIMENTS

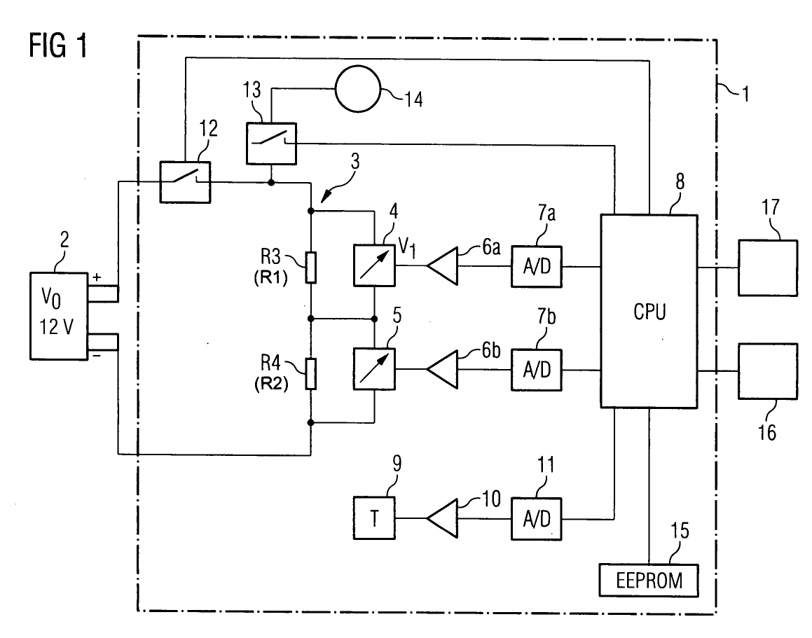

Referring now to the figures of the drawing in detail and first, particularly, to FIG. 1 thereof, there is shown a self-calibrating device 1 for determining a voltage Vo of a battery 2. By way of example, the battery may be located in a motor vehicle. The battery voltage Vo is measured by means of a voltage divider 3, which is formed by series-connected components (resistors) R₁ and R₂. The resistance values R₁ and R₂ correspond to resistance values that are present during the manufacture of the device at a given temperature. The device is therefore calibrated in the manufacturing facility at least at this temperature.

During live operation the temperature and the values R₁ and R₂ change to R₃ and R₄.

FIG. 1 shows a first voltage meter 4, which is able to measure a voltage that drops across the resistor R₁ (R₃) and a second voltage meter 5 which is able to measure a voltage that drops across the resistor R₂ (R₄).

The voltages V₁, and V₂ measured by the voltage meters 4 and 5 are in each case amplified for example by means of amplifiers 6a, 6b respectively, chopped by means of non-illustrated choppers, converted by A/D converters 7a, 7b respectively, de-chopped by means of a non-illustrated de-chopper and filtered by a non-illustrated filter before the measurement signals are forwarded to a microprocessor (CPU) 8 for further processing.

Alternatively a multiplex technique can be employed. In this case one A/D converter 7 and one amplifier 6 is sufficient.

The device 1 further includes a temperature sensor 9. The temperature signal supplied by the temperature sensor 9 is amplified for example by means of an amplifier 10 and converted by means of an A/D converter 11 into a digital signal before it is passed to the processor 8 for further processing.

FIG. 1 also shows a first switch 12, which in its closed state connects the battery voltage Vo to the voltage divider 3. The switch 12 is preferably controllable, with the opening and closing of the switch 12 being capable of being controlled by the microprocessor 8.

The preferred exemplary embodiment of the device 1 also contains a second switch 13. The switch 13 can also be controlled by the microprocessor 8 and can be closed and opened by the latter. In the closed state of the switch 13 a reference current source (preferably a constant current source) 14 is connected to the voltage divider 3. A voltage source can also be used instead of the constant current source 14.

The two switches 12 and 13 are controlled by the microprocessor 8 in push-pull mode for example, thereby ensuring that only one of the switches 12, 13 is closed at any given time and the other is open. Alternatively, however, it is also possible for both switches to be closed at the same time.

FIG. 1 also shows a memory 15, which is an EEPROM, for example, in which temperature values and calculation results of the microprocessor 8 can be stored. In particular, actual resistance ratios of the resistors of the voltage divider 3 are stored together with the corresponding temperature values, so that a resistance ratio that has been calculated once for a specific temperature can be reused subsequently.

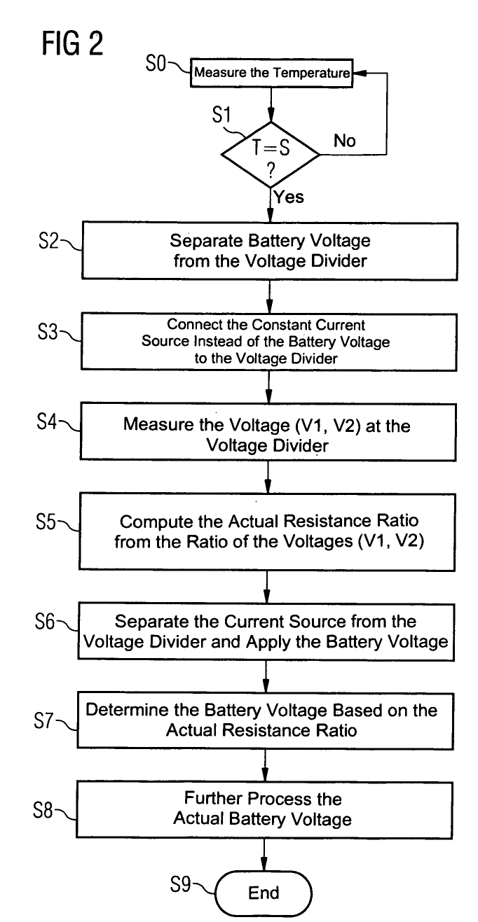

As will be described later with reference to FIG. 2, the microprocessor 8 calculates an actual battery voltage, in which temperature effects and aging phenomena of the resistors are taken into account, from a battery voltage measurement value based on the actual resistance ratio of the resistors R₃ and R₄. Said actual battery voltage can be output by the microprocessor 8 for further processing, for example to a display 16, to a generator controller 17 or to a battery monitoring device for calculating the battery condition.

The operating principle of the self-calibrating device according to FIG. 1 will be described below with reference to FIG. 2.

According to a preferred exemplary embodiment of a method for automatic calibration of the device for measuring a battery voltage according to FIG. 1, a temperature T in the vicinity of the device 1 is measured for example continuously in step S0 by the temperature sensor 9 and supplied to the microprocessor 8.

In step S1, the latter compares the obtained temperature value T with previously specified values, which can be stored for example in the memory 15. These values are typically values in which measurement results of the voltage divider can be distorted due to temperature dependencies of the resistors. If an obtained temperature value T tallies with a value S stored in the memory 15, then the method is continued in step S2, where the actual calibration first starts, where applicable in accordance with the status of the automotive electrical system and the temperature.

If an obtained temperature value T does not tally with a value S stored in the memory 15, a return branch to step S0 is made. In this case no calibration on account of temperature changes is necessary.

In step S2, the voltage divider 3 is separated from the battery as a result of the microprocessor 8 opening the switch 12.

Next, in step S3, the switch 13 is closed by the microprocessor 8, thereby connecting the current source 14 to the voltage divider 3.

Steps S2 and S3 can also be modified such that both switches are closed at the same time, with the result that it is not necessary to separate the battery voltage from the voltage divider.

A constant current I now flows in the voltage divider 3. As a result, a voltage V₁ and V₂ drops across the resistors R₃ and R₄ respectively, said voltage in each case being measured by the voltage meters 4 and 5 in step S4 and being forwarded, following appropriate processing (as described with reference to FIG. 1), to the microprocessor 8.

On the assumption that measurement values are linearly related to input values (V₁₃ Meas=a+b×V_in), the voltage meters 4, 5 supply the following measurement values at a temperature T:
V₁(T)=a₁(T)+b₁(T)R₃×I(T) (1)
V₂(T)=a₂(T)+b₂(T)R₄×I(T) (2)

where V₁(T) is the voltage determined at the temperature T via the resistor R₃. The factors aᵢ(T) and bᵢ(T) are dependent on numerous parameters, where a is approximately 0 and b is approximately 1. Said parameters aᵢ and bᵢ are determined at a specific temperature during the one-time calibration in the manufacturing facility. I(T) is the constant current supplied by the current source 14 at the temperature T.

In step S5, the microprocessor 8 calculates the actual resistance ratio of the resistors R₃ and R₄ of the voltage divider 3, which ratio is present at the temperature T, from the ratio of the voltages V₁(T) and V₂(T).

This calculated resistance ratio can be stored for example together with the temperature value T in the memory 15 so that it. can be used again subsequently.

Next, in step S6, the current source 14 is separated from the voltage divider 3 by opening of the switch 13 and the battery 2 is connected to the voltage divider 3 by closing of the switch 12. The switches 12, 13 are controlled in this case by the microprocessor 8, as described above.

In step S7, the voltage V₃(T) dropping across the resistor R₄ of the voltage divider 3 is now measured. The following applies:

$${V}_{3} ( T ) = {a}_{3} ( T ) + {b}_{3} ( T ) \frac{{R}_{4}}{{R}_{3} + {R}_{4}} {V}_{0} ; \qquad ( 3 )$$

where V₀ is the actual battery voltage being sought.

According to the preferred exemplary embodiment, the resistor R₄ is very much smaller than R₃ (for example, R₃=47 K□; R₄=100 □. Equation (3) can therefore be approximated as follows:

$${V}_{3} ( T ) = {a}_{3} ( T ) + {b}_{3} ( T ) \frac{{R}_{4}}{{R}_{3}} {V}_{0} ; \qquad ( 4 )$$

The battery voltage V₀ being sought is produced by reformulation of equations (1), (2) and (4):
[V₁(T)−a₁(T)]/b₁(T)=R₃*I(T)
[V₂(T)−a₂(T)]/b₂(T)=R₄*I(T) and
V₀=[V₃(T)−a₃(T)]*R₃/R₄/b₃(T)=[V₃(T)−a₃(T)]*[V₁(T)−a₁(T)]/[V₂(T) −a₂(T)]/b₁(T)*b₂(T)/b₃(T)

However, V_{0 and a}ᵢ, bᵢ can be approximated as follows:
V₀=V₀(T=0)+dV/dT(T=0)*T,
aᵢ(T)=aᵢ(0)*(1+xᵢ*T)
bᵢ(T)=bᵢ(0)*(1+yᵢ*T)

The result from this is

$${V}_{0} = [ {V}_{3} ( T ) - {a}_{3} ( 0 ) ] * [ {V}_{1} ( T ) - {a}_{1} ( 0 ) ] / [ {V}_{2} ( T ) - {a}_{2} ( 0 ) ] / {b}_{1} ( 0 ) * {b}_{2} ( 0 ) / {b}_{3} ( 0 ) - {x}_{3} * {a}_{3} ( 0 ) * [ {V}_{1} ( T ) - {a}_{1} ( 0 ) ] / [ {V}_{2} ( T ) - {a}_{2} ( 0 ) ] / {b}_{1} ( 0 ) * {b}_{2} ( 0 ) / {b}_{3} ( 0 ) - {x}_{1} * [ {V}_{3} ( T ) - {a}_{3} ( 0 ) ] * {a}_{1} ( 0 ) / [ {V}_{2} ( T ) - {a}_{2} ( 0 ) ] / {b}_{1} ( 0 ) * {b}_{2} ( 0 ) / {b}_{3} ( 0 ) + {x}_{2} * [ {V}_{3} ( T ) - {a}_{3} ( 0 ) ] * [ {V}_{1} ( T ) - {a}_{1} ( 0 ) ] * {a}_{2} ( 0 ) / {[ {V}_{2} ( T ) - {a}_{2} ( 0 ) ]}^{2} / {b}_{1} ( 0 ) * {b}_{2} ( 0 ) / {b}_{3} ( 0 ) - {y}_{1} * [ {V}_{3} ( T ) - {a}_{3} ( 0 ) ] * [ {V}_{1} ( T ) - {a}_{1} ( 0 ) ] / [ {V}_{2} ( T ) - {a}_{2} ( 0 ) ] / {b}_{1} ( 0 ) * {b}_{2} ( 0 ) / {b}_{3} ( 0 ) + {y}_{2} * [ {V}_{3} ( T ) - {a}_{3} ( 0 ) ] * [ {V}_{1} ( T ) - {a}_{1} ( 0 ) ] / [ {V}_{2} ( T ) - {a}_{2} ( 0 ) ] / {b}_{1} ( 0 ) * {b}_{2} ( 0 ) / {b}_{3} ( 0 ) - {y}_{3} * [ {V}_{3} ( T ) - {a}_{3} ( 0 ) ] * [ {V}_{1} ( T ) - {a}_{1} ( 0 ) ] / [ {V}_{2} ( T ) - {a}_{2} ( 0 ) ] / {b}_{1} ( 0 ) * {b}_{2} ( 0 ) / {b}_{3} ( 0 ) = [ {V}_{3} ( T ) - {a}_{3} ( 0 ) ] * [ {V}_{1} ( T ) - {a}_{1} ( 0 ) ] / [ {V}_{2} ( T ) - {a}_{2} ( 0 ) ] / z ( 0 ) * [ 1 - {y}_{1} + {y}_{2} - {y}_{3} - {x}_{1} * {a}_{1} ( 0 ) / [ {V}_{1} ( T ) - {a}_{1} ( 0 ) ] + {x}_{2} * {a}_{2} ( 0 ) / [ {V}_{2} ( T ) - {a}_{2} ( 0 ) ] - {x}_{3} * {a}_{3} ( 0 ) / [ {V}_{3} ( T ) - {a}_{3} ( 0 ) ] ]$$

where z(0)=b₁(0)*b₂(0)/b₃(0); xᵢ and yᵢ lie in the same order of magnitude, but aᵢ is considerably smaller than Vᵢ. The battery voltage to be determined is therefore
V₀=[V₃(T)−a₃(0)]*[V₁(T)−a₁(0)]/[V₂(T)−a₂(0)]/z(0)*[1−y₁y₂−y₃]

Since all temperature coefficients yᵢ have similar values given suitable selection of the amplifier, the error of the voltage measurement is now only approximately 8 ppm/C.

In step S8, the correct actual battery voltage is processed further, passed on, for example, to the generator circuit 17 according to FIG. 1 or simply displayed on the display 16 according to FIG. 1.

The method for self-calibration of the device 1 performed for the temperature T terminates in step S9.

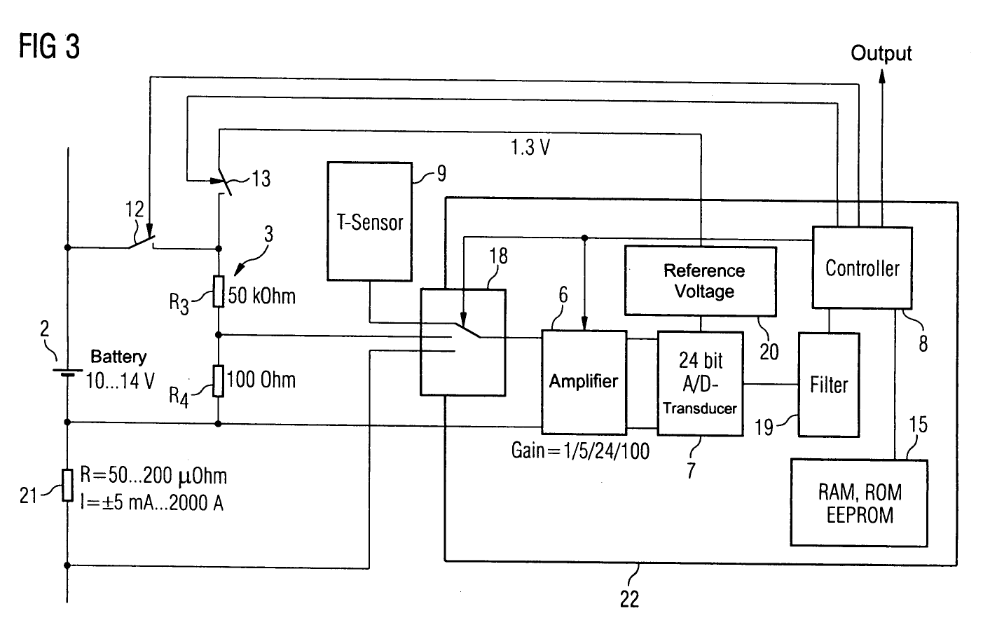

FIG. 3 shows a block diagram of a self-calibrating device for measuring a battery voltage of a battery 2 according to a second exemplary embodiment, with the same or corresponding components in FIG. 3 having the same reference numerals as in FIG. 1.

In contrast to the first exemplary embodiment according to FIG. 1, the second exemplary embodiment according to FIG. 3 includes a multiplexer 18 which is controlled accordingly by a controller (CPU) 8. It is thus possible to use just one amplifier 6, one A/D converter 7 and one filter. 19.

According to the second exemplary embodiment a reference voltage 20 is connected to the A/D converter 7 and can be connected to the voltage divider 3 by closing of the switch 13.

The voltage divider 3 according to the second exemplary embodiment is formed for example from series-connected resistors R₃=50 KΩand R₄=100 Ω.

As shown in FIG. 3, a nodal point (junction) between the resistors R₃ and R₄ is connected directly to the multiplexer 18. One end of the resistor R₃ is connected to each of the switches 12 and 13. The switches 12 and 13 are controlled accordingly by the controller 8. When the switch 13 is closed, said one end of the resistor R₃ is connected to the reference voltage 20. When the switch 12 is closed, said one end of the resistor R₃ is connected to the positive pole of the battery 2.

One end of the resistor R₄ is connected to the negative pole of the battery 2 and to the amplifier 6. The amplifier 6 has for example a gain of 1/5/24/100.

FIG. 3 also shows a resistor 21 which has, for example, the order of magnitude of 50 . . . 200 μΩ. One end of the resistor 21 is connected to the negative pole of the battery 2, one end of the resistor R₄ and the amplifier 6. The other end of the resistor 21 is connected to ground and to the multiplexer 18.

As shown in FIG. 3, the multiplexer 18, the amplifier 6, the A/D converter 7, the filter 19, the reference voltage 20, the controller 8 and a memory (for example RAM, ROM, EEPROM) 15 are embodied for example on an ASIC component 22.

According to the second exemplary embodiment the temperature sensor 9 is embodied separately from the ASIC component 22 and connected to the multiplexer 18.

In a similar way as according to the first exemplary embodiment, the controller 8 can output battery condition signals to a display or a generator controller (not shown).

According to the exemplary embodiment shown in FIG. 3, the reference voltage supplies a value of 1.3 volts.

Although in the foregoing the invention has been described in detail and with reference to a preferred exemplary embodiment, it is self-evident that modifications and changes can be made without departing from the protective scope of the invention.

In particular, for example, the reference current or reference voltage source can be embodied outside of the voltage measuring device. The individual elements of the voltage measuring device 1 can be implemented for example fully or partially by means of an ASIC chip, whereby a software program can be included in the memory.

The calibration can be performed for example in addition or alternatively periodically independently of the temperature at arbitrary points in time.

The self-calibration can also be performed for example when the. battery current falls below or exceeds a predetermined threshold value.

This application claims the priority, under 35 U.S.C. § 119, of German patent application No. 102004022556.7, filed May 7, 2004; the entire disclosure of the prior application is herewith incorporated by reference.

1. A device for measuring voltage, comprising:
a voltage divider formed by series-connected resistors R₃, R₄ for measuring a battery voltage V₀;
a first switch having an open position disconnecting the battery voltage from said voltage divider;
a second switch having a closed position connecting a reference current source or a reference voltage source to said voltage divider;
a measuring device connected to said voltage divider for measuring respective voltages dropping across said voltage divider; and
a calculating device connected to said measuring device and configured to calculate an actual resistance ratio of said resistors R₃, R₄ of said voltage divider based on the measured voltages when said second switch is in the closed position, and an actual battery voltage based on the calculated resistance ratio.

2. The device according to claim 1, wherein at least one of said series-connected resistors is a component across which voltage drops.

3. The device according to claim 1, which further comprises a temperature sensor for recording a current temperature value, and wherein said calculating device is configured to calculate the resistance ratio of said resistors of said voltage divider at predetermined temperature values and to determine an actual battery voltage based on the resistance ratio at the temperature.

4. The device according to claim 3, which further comprises a memory for storing the resistance ratio calculated for a given temperature.

5. A method of automatically calibrating a voltage measuring device, which comprises the following method steps:
connecting a reference current or reference voltage source to a voltage divider and measuring respective voltages dropping across the voltage divider;
calculating an actual resistance ratio of the resistors of the voltage divider based on the voltages measured in the measuring step; and
determining a battery voltage V_{0 with the voltage divider, taking into account the resistance ratio calculated in the calculating step.}

6. The method according to claim 5, which comprises measuring a temperature T and performing the connecting, calculating, and determining steps at predetermined temperatures.

7. The method according to claim 6, which comprises storing a resistance ratio of the resistors of the voltage divider, wherein the resistance ratio has been calculated for a specific temperature.
